(19) United States
(12) Patent Application Publication
(10) Pub. No.: US 2003/0074430 A1
(43) Pub. Date: Apr. 17, 2003

(54) Object oriented provisioning server object model

(76) Inventors: Eric James Gieseke, Lincoln, MA (US); Huimin Li, Milford, MA (US)

Correspondence Address: LEFFERT JAY & POLGLAZE, P.A., P.O. BOX 581009, MINNEAPOLIS, MN, 55458-1009, US

(21) Appl. No.: 09/972,844

(22) Filed: Oct. 5, 2001

(51) Int. Cl. G06F 15/177

(52) U.S. Cl. 709/221; 709/224

(57) ABSTRACT

A provisioning server object model and method is detailed that manages configuration and tasking of devices, elements, or links of networks. The provisioning server object model and method utilizes an object oriented design and object cache that allows the provisioning server to generate configuration responses for network elements, command lists, network state, and import and export configuration information in an efficient manner. The provisioning server object model and method also allows for dynamic updates of configuration components by identifying stale configuration components and managing their dynamic updating in response to configuration change events that affect the underlying input files and information databases.

### TECHNICAL FIELD

The present invention relates generally to provisioning servers and in particular the present invention relates to object models of provisioning servers with object oriented design and components in networks.

### BACKGROUND

Modern networks and network systems are typically constructed of multiple differing devices, elements, or links, referred to collectively herein as elements. These elements can each have multiple configurations, settings, and polices depending on the specific task the element has within the network or system. Additionally, the elements are often of a general application type such that they require configuration to perform their purpose in the network or network system. This configuration of network elements is called “provisioning”. Examples of such networks and network systems include cable modem networks, etc.

Configuring and tasking elements in networks and network systems is typically the task of a “provisioning” server. In a network system there typically exist network elements of many types and from multiple manufacturers. Each network element type commonly has a configuration file that is generated for it or provided from the manufacturer that models how the network element operates and should be configured. In addition, elements in a network have specific tasks and assignments that require specific configuration parameters or belong to a class of network elements that get a class or specific configuration parameters from a range of configuration parameters. In configuring and tasking network elements the provisioning server combines the element type configuration with the application or task configuration to come up with a specific configuration for the device within the network.

These configurations are generally “static” or “dynamic” in nature. A static configuration is defined as being of fixed purpose or task in the network with a static configuration that does not change from element configuration loading to loading. For ease of operation, a provisioning server typically converts the static configurations into specific purpose configuration files or information in an information database that are saved in the provisioning server for repeating use. Such static configurations can also be generated dynamically from the underlying network element type and task configuration. An example of a statically configured network element is a cable modem (CM) that has an internet protocol (IP) number, polices, and service level that it is assigned, statically, every time it asks for configuration. A dynamic configuration is defined as being of a general class of elements or purpose that has a configuration that can dynamically change from element configuration loading to loading. Typically, a dynamic configuration is based on a class of service provided to one or more end-users. Such dynamic configurations are generally generated as needed by the provisioning server, as they tend to contain variable elements, although they also can be saved in the provisioning server configuration files and/or information database. An example of a network element with a dynamic configuration is a CM that utilized a dynamic host configuration protocol (DHCP) to “lease” an IP number with dynamically assigned policies and service levels.

Modern provisioning servers are typically internally comprised of a database containing configuration information, a storage medium that contains text and binary configuration files, and internal routines. Provisioning servers are also commonly internally comprised of “provisioning components”, also known as “configuration components”, that are generally represented in an internal table. The provisioning components are utilized by a provisioning server to generate the required configuration for a particular network element or system element that requests it. The provisioning components in turn are typically loaded on demand by the provisioning server, or at initialization, from underlying configuration input files or information databases for all known hardware that is connected to the network or network system that the provisioning server is responsible for. Once the provisioning components are initialized or loaded on demand the provisioning server can generate and send out the appropriate configurations to the requesting elements, devices, and services in the network or network system under management.

In operation, when a request for configuration comes into a provisioning server, if a configuration file for the requesting element, device, or service exists on the storage media it is checked against the configuration information held in the database to see if it is current. If the file is current it is sent to the requesting network element, typically by file transfer protocol (FTP) or trivial file transfer protocol (TFTP). If the configuration file for the requesting element, device, or service does not exist or is out of date, the provisioning server loads the information from the database into the provisioning components and generates a configuration file for the requesting element, device, or service, places it on the storage media and sends it to the requesting network element.

For provisioning servers, accessing the database to check to see if a configuration file is current, and loading the provisioning components from information databases to generate configuration files is time consuming and a large source of provisioning server resource consumption and system load. Additionally, for provisioning servers loading and conversion of the provisioning components to and from configuration input files and information databases is also time consuming, and error prone. Manufacturers of various network elements also commonly provide configuration files for use in provisioning the network elements in a network environment. However, the configuration files are often of varying formats and are typically specific to the device or element. This multitude of configuration input file formats requires that the provisioning server utilize specialized conversion modules or techniques in reading or writing them. The arrangement of the configuration file translation modules or routines for the provisioning server is highly prone to oversight and error. This particularly leads to variability and problems when the provisioning server is called upon to convert from one configuration input file format to another (such as from a manufacturer's ASCII configuration file format to a binary format). Likewise, the reading and/or writing of this network element configuration information to and from an associated information database, which may have its own internal format, is also prone to translation errors. An example of such an associated information database is a lightweight directory access protocol (LDAP) server.

Networks and network systems are typically rarely ever static in their configuration and setup. Changes or additions are often quite frequently made to the network or system by users, administrators, or other programs and/or devices. These changes or additions are seen at the provisioning server as “configuration change events” and have the effect of changing or adding to the provisioning components maintained by the provisioning servers. A typical configuration change event is affected or initiated by a simple network management protocol (SNMP) request to the provisioning server. However, other configuration change events or inputs are possible.

In current provisioning servers, provisioning multiple network elements can take a large amount of time to complete. Primarily, this is because of the large number of applications for the managed network elements, checking if configuration files are current by references to the database, loading and generating new configuration files, converting the various configuration files, the variability in the types and manufacture of the network elements, and the variability of the individual dynamic and static element configuration.

Requests for configuration at provisioning servers also tend to be “bursty” in nature, with large numbers of requests coming in a short duration of time followed by long periods of relative inactivity. This bursty configuration activity is generally due to restoration of all or part of a managed network because of various issues. At these times large numbers of network elements seek to once again become part of the managed network and suddenly request configuration information all at once. Examples of such network issues include power outages, loss of communication to all or certain network segments, and administrator actions and maintenance. Such high activity burst periods of configuration requests can quickly overwhelm a provisioning server's ability to service the requests. Much of the provisioning server load at these times is owed to loading or converting configuration files and information database entries to allow configuration requests to be serviced.

To be able to manage a system the administrator or managing program must be able to know what it is capable of. One of the many ways to manage a provisioning server is through SNMP or a command line interface (CLI). In SNMP or through the CLI this listing of capability is accomplished by the “show running config” command or by loading the required management information base (MIB). Upon receiving the “show running config” command, the provisioning server generates a list of commands and configurations that the system it is capable of.

In provisioning servers, this generation of the “show running config” CLI command set or SNMP MIB generation can take a large amount of time to complete. Primarily, this is because of the large number of applications for the provisioning server and the elements it manages in a network, the variability in the managed elements, and the variability of the element configuration. The command set and MIB generation can also be a significant load on the provisioning server degrading its performance. Command set and MIB generation can both take up to several minutes to generate and complete.

Given the intricacy of SNMP implementation, particularly in complex systems, there is difficulty in programming and verifying SNMP interfaces in provisioning servers. This is particularly the case given frequent updates to the managed elements and additions of new elements to be managed.

For the reasons stated above, and for other reasons stated below which will become apparent to those skilled in the art upon reading and understanding the present specification, there is a need in the art for an object model and method for conveniently making, expanding, and operating provisioning servers to allow managing and updating of configurations and network elements in a network environment.

### SUMMARY

The above-mentioned problems with conveniently making, expanding, and operating provisioning servers to allow managing and updating of configurations and network elements in a network environment are addressed by embodiments of the present invention and will be understood by reading and studying the following specification.

In one embodiment, an object model includes a number of objects adapted to contain configuration information and data for a provisioning server.

In another embodiment, a method of forming an object model for a provisioning server includes receiving configuration input, and representing the received configuration input in object instances of a number of objects forming an object model.

In yet another embodiment, a computer-usable medium has computer readable instructions stored thereon for execution by a processor to perform a method. The method includes receiving configuration input, representing the received configuration input in object instances of a number of objects forming an object model, and responding to requests for configuration information from one or more elements of a network.

In a further embodiment, a provisioning server includes a memory, a network interface, a processor coupled to the memory and the network interface, and an object model. The object model includes a number of objects adapted to contain configuration information and data for network elements of a network system managed by a provisioning server.

In yet a further embodiment, an object model for a provisioning server includes a number of objects adapted to contain configuration information and data for one or more input configuration datum.

In another embodiment, a provisioning server has a memory, a network interface, a computer-usable medium for storing computer readable instructions, an object model, and a processor coupled to the memory, the computer-usable medium, and the network interface. The object model includes a number of objects adapted to contain configuration information and data for one or more input configuration datum.

Other embodiments are described and claimed.

### BRIEF DESCRIPTION OF THE DRAWINGS

FIG. 1 is a simplified diagram of a provisioning server in a network.

FIG. 2 is a simplified diagram of an embodiment of the present invention.

FIG. 3 is a simplified diagram of an object model of an embodiment of the present invention.

FIG. 4 is a simplified flowchart of a timestamp verification of an embodiment of the present invention.

FIG. 5 is another simplified diagram of an object model of an embodiment of the present invention.

### DETAILED DESCRIPTION

In the following detailed description, reference is made to the accompanying drawings that form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims.

Embodiments of the present invention include network provisioning servers that utilize object oriented programming techniques to model and configure their managed system, which is typically a network system or cable modem network. Embodiments of the present invention import, export, and convert to and from configuration files and associated information databases with object oriented processes. Embodiments of the present invention service configuration requests from internal object oriented data structures. Embodiments of the present invention also dynamically update their internal configuration components upon receiving a configuration change event and, additionally, allow for generation of a CLI command set without excessive loading of the provisioning server or degradation of its performance.

As stated above, provisioning servers are a commonly used element of network environments that are used to configure network elements and to set policies and service levels. Provisioning server embodiments of the present invention are typically internally comprised of a database containing configuration information, a storage media that contains text and binary configuration files, internal routines (which may or may not be object oriented in nature), and provisioning objects (also known as configuration objects). The provisioning objects are utilized by provisioning server embodiments of the present invention to generate the required configuration for a particular network element or system element that requests it. The provisioning objects in turn are typically loaded on demand by the provisioning server from the information database or, alternatively, from configuration input files on the storage media. Once the provisioning objects are loaded the provisioning server can generate and send out the appropriate configuration to the requesting element, device, and service in the network or network system under management. Configurations in embodiments of the present invention are non-format specific to allow for the provisioning of any type of network element or system it is tasked to provision, but are typically a binary file or data stream. Once loaded the provisioning objects are retained in the provisioning server embodiment of the present invention as a “cache” of provisioning information and the generated the configuration is saved to the storage media for possible future use. Typically, a provisioning object cache size is set to avoid overloading the provisioning server and provisioning objects are removed from the cache with a least recently used (LRU) algorithm that guarantees that commonly used provisioning object will be available in the cache. It is noted that other cache algorithms are possible and should be apparent to those skilled in the art with the benefit of the present disclosure. In one provisioning server embodiment of the present invention multiple provisioning object caches with separately adjustable cache sizes are organized by network element type, class of network element, service, or other provisioning type or action that shares a commonality. A network element in the present disclosure is defined as any system, element, device, or service that a provisioning server embodiment of the present invention would provision for in a network.

In operation, when a request for configuration comes into a provisioning server embodiment of the present invention if a configuration or configuration file for the requesting element, device, or service exists on the storage media it is checked against the provisioning objects for the network element if they are loaded in the provisioning servers provisioning object cache to see if it is current. If the file is current, it is sent to the requesting network element by the specified delivery method for the network element, which is non-specific and includes, but is not limited to, FTP, and TFTP. If the configuration file for the requesting element, device, or service does not exist or is out of date, the provisioning server loads the information from the database or input configuration files into provisioning objects in the cache and generates a configuration or configuration file for the requesting element, device, or service. The provisioning server then places the configuration or configuration file on the storage media and sends it to the requesting network element. In this manner if provisioning objects are present for the network element in the provisioning object cache and up to date, accesses to the database are eliminated. Thus provisioning configuration information/files can be served by provisioning server embodiments of the present invention with just a few timestamp checks. The provisioning server resource intensive configuration information/file generation also happens as needed, thus allowing a fast response time for configuration requests to provisioning server embodiments of the present invention.

A provisioning server is typically specific to a system or elements that comprise a system and a communication interface that allows for configuration of those elements. An example of common communication interfaces are a data over cable service interface specification (DOCSIS) interface, a media termination adapter (MTA) interface (packet cable), a simple network management protocol (SNMP) interface, a dynamic host configuration protocol (DHCP), a FTP interface, a TFTP interface, and etc. An example of a common network implementation that contains a provisioning server is that of a cable modem (CM) network implementing DOCSIS wherein multiple cable modem types (of both DOCSIS 1.0 and DOCSIS 1.1), network links, policies, service level agreements (SLAs), and quality of service agreements (QoS) exist. Provisioning servers in a network system are responsible for implementing and maintaining a desired configuration for the system and all elements to match the application or applications for which the system is specifically being used. Examples of such possible applications are a DHCP server, a cable modem termination system (CMTS), a CM, a MTA, a cell phone or cellular system, or any other network element or device that can require configuration in static or dynamic manner. In implementing and maintaining a desired system configuration, provisioning servers provide to each element or other network component the appropriate configuration, policy setting, QoS, and/or SLA setting desired for that element. The configuration, policy setting, QoS, and/or SLA setting are referred to herein as a “configuration”. Network elements in this definition include, but are not limited to, network links, routers, cable modems (CMs), CMTS, media termination adapters (MTAs), voice channels (plain old telephone service (POTS), voice over internet protocol (VOIP), etc.), data channels, cell phones, and SNMP compliant devices or agents.

In some embodiments, provisioning servers of the present invention utilize an object oriented design (OOD) approach to implementation. In some embodiments of the present invention, elements of the system are represented in the provisioning server by objects in an object model. This also allows for the provisioning server to be wholly implemented with object oriented programming (OOP) or just the managed elements in an object model. This allows instances of the “provisioning” objects, also known as “configuration” objects, to be the provisioning components that are affected by configuration change events with the added benefit of being capable of internalizing object methods and attributes to aid in operation of the provisioning server embodiment of the present invention. The provisioning components contain all configuration information and necessary attributes and routines to manage the corresponding element that they represent.

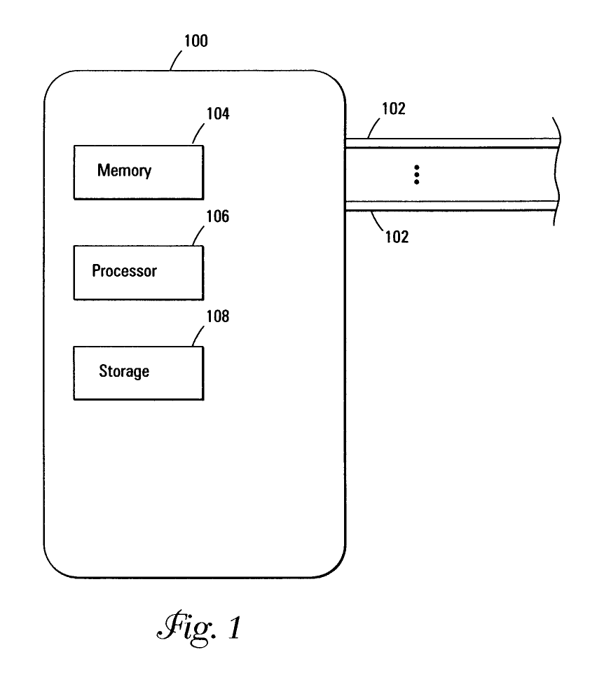

Provisioning servers generally take the physical form of a network element in a managed network system, as shown in FIG. 1. The provisioning server 100 has in one embodiment a network interface 102, a memory 104, a processor 106, and a storage element or storage medium 108 that is in one embodiment a computer-readable media. Computer-readable media is defined for the purposes of this disclosure as a set of computer-readable instructions stored on a computer-usable medium for execution by a processor. Examples of computer-usable media include, but are not limited to, removable and non-removable magnetic media, optical media, dynamic random-access memory (DRAM), static random-access memory (SRAM), read-only memory (ROM) and electrically-erasable and programmable read-only memory (EEPROM or Flash). It is noted that provisioning servers can take multiple other physical forms, including, but not limited to, provisioning servers that are functions of other network elements, or network elements that have the provisioning server functionality expressed in firmware or even hard-coded in a device such as an application-specific integrated circuit (ASIC) chip.

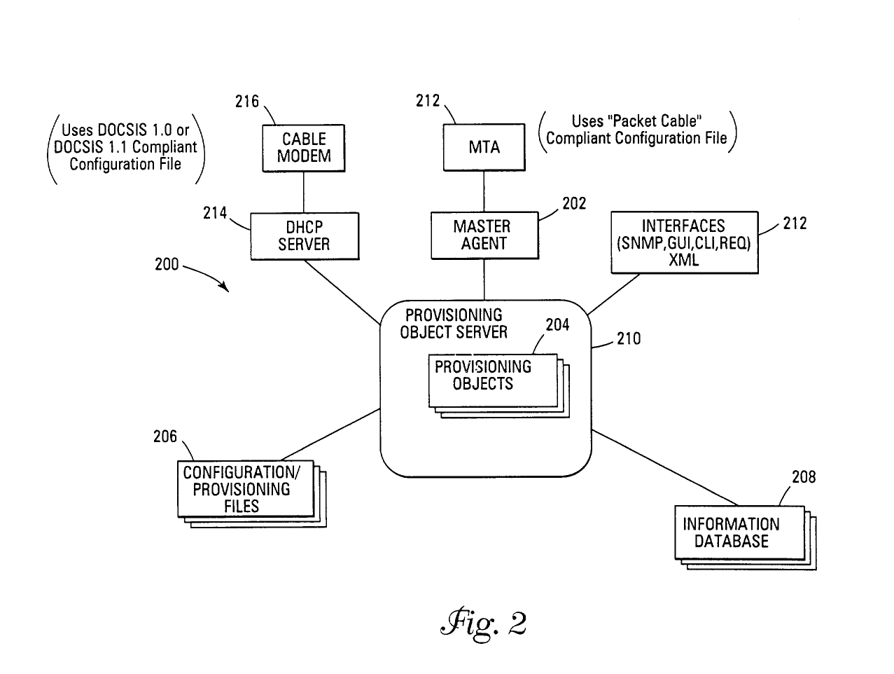

FIG. 2 is a simplified diagram of a provisioning server system embodiment of the present invention. The provisioning server system 200 includes a master agent 202, configuration objects 204, configuration files 206, a provisioning object server 210, DHCP server 214, interfaces 212, and a database 208 to store the provisioning configuration of the managed network. The master agent 202 handles all communication and requests to and from the provisioning object server 210 to “packet cable” compliant MTA devices 212. Similarly, the DCHP server 214 handles all communication and requests to and from the provisioning object server 210 to DOCSIS 1.0 or 1.1 compliant cable modems 216. Additionally, the provisioning server system 200 can contain interfaces 212 for SNMP, a CLI, a graphic user interface (GUI), an extensible mark-up language (XML) interface, or any other interface for configuration requests from network elements. The provisioning objects 204 are arranged in an internal object hierarchy that is generated from an object model that is designed to represent the elements of the managed network. The provisioning objects 204 are controlled in the provisioning server system 200 by the internal provisioning object server 210. Configuration information is imported and exported from the provisioning objects 204 to and from provisioning/configuration files 206 and information database 208 as required.

When a request for configuration comes in to the provisioning server system 200 the request is routed by the master agent 202, DHCP server 214, or other interface 212 through the provisioning object server 210 to the appropriate provisioning object 204, if the appropriate object instantiation exists for the request. If no object instantiation exists for the request, the appropriate object instantiation is loaded from the configuration information stored in the information database 208 or configuration files 206 by the provisioning object server 210 which instantiates, loads, and unloads them as needed by the provisioning server system 200. The provisioning object 204, when it receives the configuration request, checks to see if a corresponding configuration file 206 exists and notes the timestamp of the configuration file 206. If the configuration file does not exist, the provisioning object 204 generates it utilizing its internal attributes and methods, and by “walking” the tree of any subordinate provisioning objects (not shown) and is saved to the associated storage media (not shown) with the other configuration files 206. If the configuration file does exist, the provisioning object 204 then checks to see if its internal configuration information and that of any subordinate provisioning objects (not shown) are up to date (older than the configuration file 206 ), and if they are, the configuration file 206 is up to date and it returns the configuration file 206 in response to the request. If the selected provisioning object 204 or any of the subordinate objects are marked stale they are updated from the configuration files 206 or information database 208. If the configuration file is older than the provisioning object 206 or any of its subordinate objects it is generated as detailed above and saved. The response is then sent back to the requesting network element by the provisioning server through the requesting interface.

Configurable network elements in modern networks typically are managed through various interfaces, which generally include but are not limited to, a GUI, a SNMP interface, and a CLI. The most common of these are the SNMP interface and the CLI. In order to manage a configurable network element with an SNMP or CLI interface, the administrator or management program performing the management has to acquire knowledge of what the device is capable of and what can be set. This is typically done through loading the information or querying the network element for an SNMP MIB. Another approach is to issue a “show running-config” command at the CLI interface, which causes the network element to list the element's current configuration and the commands it is capable of. For a network system, this listing of current configuration in the form of a CLI command listing can be issued by the provisioning server and covers each element managed in the network. The configuration also includes alarm configuration, protocol configuration, SNMP configuration, and IP configuration.

Configuration change events, which are events that require a change in one or more provisioning objects, database, or files maintained by the provisioning server, occur on a frequent basis in networks and effect a change to the system or network being managed. In provisioning servers, the maintained provisioning objects are generated from input configuration files or information databases and reflect the desired state of the managed network or system. The provisioning objects are utilized to generate the configuration that is sent back to each element of the system or network as that element requests it. The provisioning objects are also utilized to generate the CLI command listing to any entity that request it via the CLI interface. Configuration changes can be introduced by human operators who modify the system configuration through the CLI, SNMP or GUI interfaces and is typically stored directly in the information database of the provisioning server, although it may alternatively be stored in configuration files. Any such change by human operators to the information database has the effect of marking the corresponding provisioning object as stale, forcing its regeneration by the provisioning server upon the next request for the provisioning object. In one embodiment of the present invention, such a database change has the effect of marking all provisioning objects as stale, forcing the regeneration of all the provisioning objects on an on-demand basis.

It is also possible to input or generate the provisioning configuration information to and from the provisioning server in the form of an ASCII formatted text configuration data file, a binary configuration file, or an extensible markup language (XML) formatted configuration data file. If the file is input to the provisioning server it triggers a change event in the system that will rebuild the affected provisioning objects. It is noted that other configuration change events or inputs are possible.

Configuration change events typically require the regeneration of the provisioning components of the provisioning server. Until a regeneration is done the provisioning server may not know which provisioning components, and therefore which generated configurations that it sends to requesting devices or services, are up to date. The regeneration operation is resource intensive in past provisioning servers and can delay responses to configuration requests, as provisioning component regeneration requires that the provisioning server stop servicing configuration requests until all components are checked and updated. In the meanwhile, all devices that request a configuration are unable to complete their setup and therefore are unavailable to the network or system or end-user until regeneration is complete, a process that can take several minutes on complex systems. As configuration change requests are a frequent occurrence the probability of this delay is high. Certain provisioning server embodiments of the present invention contain methods internal to the objects that represent the provisioning components that automatically update upon receiving a configuration change event that modifies the object or underlying configuration input files or information databases. An example of such an updating provisioning server is described in the U.S. patent application Ser. No. (Attorney Docket No. 100.235US01), which is commonly assigned and is incorporated herein by reference.

As stated above, the programming and setup of provisioning servers has traditionally been an intensive and time consuming process that has a high probability of error. This is due in part to the complexity of building a provisioning server based on multiple format network element configurations, configuration import from files and databases, configuration export to files and databases, and configuration file generation methods. The result is that there are often multiple updates of released products to fix implementation errors and reliability problems. Additionally, when new network element types must be added to the set of network elements that the provisioning server manages, this addition is also complex and very seldomly can reuse the same implementation code.

In an alternative embodiment of the present invention, as configuration change events come into the provisioning server, the appropriate provisioning object instance that contains the provisioning component information for the element that is being affected is notified if it is loaded and present in the memory of the provisioning server. If the provisioning object instance is not present in the provisioning server it is loaded from either the attached information database or the configuration files as is appropriate. The provisioning object then handles the configuration change event and the internal configuration information that it manages is updated. Additionally, the network element managed by the provisioning server and/or underlying configuration file and information database are updated if required.

In embodiments of the present invention, provisioning objects also allow for ease of configuration file import and export by coding the methods into the object for the element that they manage. Alternatively, specific import and export objects can be programmed in embodiments of the present invention that are tasked with handling import and/or export to and from provisioning objects and specific configuration file formats or information databases. As stated above, it is possible to input or export the provisioning configuration information to and from the provisioning server in the form of an ASCII formatted text configuration data file, a binary configuration file, or an extensible markup language (XML) formatted configuration data file. XML configuration data files have the advantage of being human or machine editable, but are format specific to types of network elements with each network element type having its own XML data type definition (DTD) that would allow the provisioning server to interpret, input, and write the format. An example of such would be a cable modem XML configuration file that is interpreted by a cable modem XML DTD. It is noted that other configuration change events or inputs are possible.

In additional embodiments of the present invention, each provisioning object knows the CLI commands and settings that its managed element accepts, allowing for the provisioning server to quickly generate “show running-config” responses by simply querying the provisioning objects. Each provisioning object is also aware of the mapping between its attributes and the associated SNMP MIB objects. In addition, each provisioning object also knows the mapping of its attributes to CLI command parameters. With this information, the provisioning objects derive the mapping from the CLI command parameter to an SNMP MIB object.

As objects in an OOP approach can inherit characteristics from parent object classes that they were built from, provisioning server embodiments of the present invention utilizing this technique allow for high amounts of code reuse in implementing provisioning server embodiments of the present invention. The code reuse and “objectization” of managed system elements in embodiments of the present invention eliminates much of the code development time and problems with errors as repeatable sections are reused and code is compartmentalized. For example, a change correcting an error in a single underlying class or extension of a class is reflected in all other classes that incorporate them. Additionally, the OOP approach with its inheritance characteristics allow for ease of extending provisioning server embodiments of the present invention to managing new devices or systems. In embodiments of the present invention building new classes, common elements are incorporated by inheritance from included object classes or a base object class and the object needs only to be extended to cover new functionality. Examples of object oriented languages that can allow for implementation of provisioning server embodiments of the present invention include, but are not limited to, C++, Java, etc.

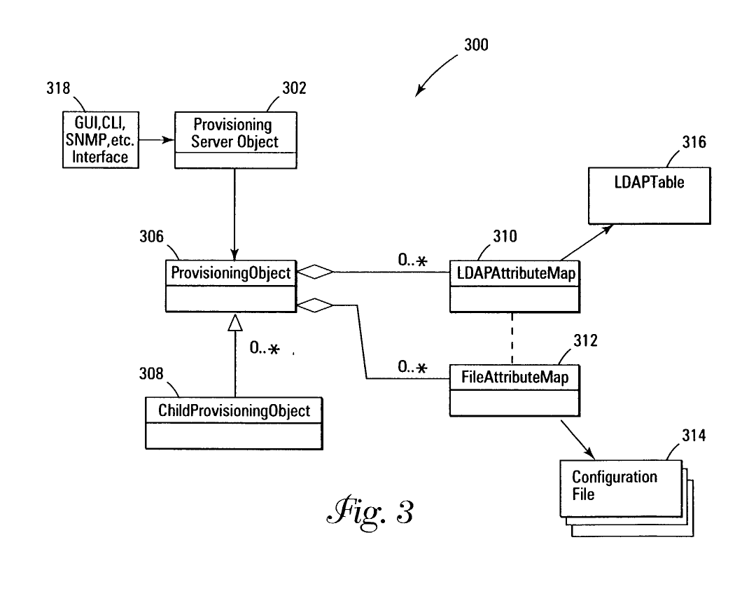

FIG. 3 is a simplified object model diagram showing an example of an object model 300 of an embodiment of the present invention. In FIG. 3, the object model 300 contains a provisioning server object 302, an interface 318, a base ProvisioningObject 306, derivative ChildProvisioningObjects 308, a LDAPAttributeMap object 310 that has an associated LDAP database table 316, and a FileAttribureMap object 312 that has associated provisioning configuration files 314.

The ProvisioningObject 306 is the base object class for all ChildProvisioningObjects 308 utilized in the object model 300. The derivative ChildProvisioningObjects 308 extend the base ProvisioningObject 306 and further define and model the specific physical and logical components, and elements of the represented network element.

In mapping a change event to an object attribute pair, the provisioning server object 302 is notified when a successful configuration event (i.e., a SNMP set request) is processed. This allows the provisioning server object 302 to update the specific object instances 306, 308 that represent of the state of elements of the network system. For each change event, the provisioning server object 302 receives from the interface 318 a represented network element type, parameter name, and value. The provisioning server object 302 then updates the associated ProvisioningObject 306, 308 instance and attribute with the value. The updated ProvisioningObject 306, 308 writes the changed configuration information out to the LDAP table 316 utilizing the LDAPAttributeMap object 310. The update of an object instance due to a configuration event triggers rebuilding of the specific configuration file 318 for the modified object instance, as described above, through the FileAttributeMap object 312 upon the next request for a configuration from the associated network element for configuration. In one embodiment of the present invention, this update marks/timestamps all ProvisioningObjects 306, 308 as stale, forcing a rebuilding of all generated configuration files 318 when they are next accessed by a provisioning request, immediately reflecting the change event. Alternatively, in another embodiment of the present invention, the provisioning server identifies and marks/timestamps as stale only those effected ProvisioningObjects 306, 308 and their generated configuration files 318. This approach allows only the effected ProvisioningObjects 306, 308 and configuration files 318 to be rebuilt, but requires a higher overhead from the provisioning server in keeping track of which ProvisioningObjects 306, 308 and generated configuration files 318 depend on which other ProvisioningObjects 306, 308. Additionally, certain embodiments of the present invention may periodically mark/timestamp all ProvisioningObjects 306, 308 and configuration files 318 as stale, forcing an update of all ProvisioningObjects 306, 308 and configuration files 318 to maintain the concurrency of the provisioning server.

There are two available manners to map the change event received from the provisioning server object 302 to an object instance and attribute. First, the change event is passed from parent object to child object within the ProvisioningObject 306, 308 hierarchy for that network element type, using the instance to route the change event to the correct object 306, 308. Second, each object instance attribute registers interest for change events with a notification service. When the notification service receives an change event corresponding to a network element type name, network element instance, and attribute matching a registered object instance, the notification service then notifies the ProvisioningObject 306, 308 that matches the network element type name, network element instance, and attribute, gaining the efficiency of not having to pass the change event from object to object within the ProvisioningObject 306, 308 hierarchy. As stated above, the notification service/mapping is handled in one embodiment by the objects of the LDAPAttributeMap 310 and the FileAttributeMap 312.

The LDAPAttributeMap 310 and the FileAttributeMap 312 object classes aggregate attributes that map to a common LDAP table 316 or configuration file 314 respectively. Both the LDAPAttributeMap 310 and the FileAttributeMap 312 object classes in one embodiment contain provide methods for initialization of requested ProvisioningObjects 306, 308 if they are not resident in the provisioning server cache. Methods are also provided for computing the instance of the ProvisioningObjects 306, 308 associated with a parameter from a LDAP table 316 or configuration file 318, and processing (data conversion) incoming and outgoing configuration data to and from their respective LDAP table 316 or configuration file 318. The LDAPAttributeMap 310 and the FileAttributeMap 312 object classes also contain methods to perform parameter reads and writes to their respective LDAP table 316 or configuration file 318.

The instances of the ProvisioningObjects 306, 308 each model a specific network element type, component, or interface and handle the generation of its portion of the configuration required for the specific represented network element instance. Each ProvisioningObject class 306, 308 also knows its contained or dependent ChildProvisioningObject classes 308 and delegates to the contained classes when it must generate a configuration or configuration file required for the specific represented network element instance, allowing the contained or dependent ChildProvisioningObject classes 308 to generate their own sections of the configuration or configuration file. By this walking of the ProvisioningObject 306, 308 instance tree, a configuration or configuration file for the specific managed network element are generated.

As a further efficiency, in some embodiments of the present invention, instances of the ProvisioningObjects 306, 308 can refer to its contained or dependent ChildProvisioningObject classes 308 by instance name. This allows ChildProvisioningObject classes 308 that are common and have the same attributes and data across multiple specific instances of ProvisioningObjects 306, 308 to be reused across those multiple specific instances of ProvisioningObjects 306, 308. This technique avoids the load, time for database access, and resource usage that would be on the provisioning server if each separate specific instance of ProvisioningObjects 306, 308 had its own unique ChildProvisioningObject class 308 instances.

Additionally, in embodiments of the present invention, is it preferred that higher level ProvisioningObjects 306, 308, such as those that represent network elements, are kept as simple as possible and contain only those attributes/parameters that are unique to the network element type and all other attributes/parameters are included with dependent or included ChildProvisioningObject classes 308. This allows flexibility to administrators to define several common configurations that are to be utilized with the network element type or types and define specific end-user configurations, such as a set of differing service levels. Modifications by the administrator to these common configuration objects are then easily reflected across all network elements that reference the common configuration objects.

Provisioning server embodiment of the present invention can also handle static configuration files and “static” provisioning/configuration objects. In the case of a static configuration file no ProvisioningObjects 306, 308 instances or classes are associated with the static configuration file. When a static configuration file is referenced it is assumed to be up to date and no configuration file generation is done, it is simply sent to the requesting network element. A static provisioning/configuration object is an object that is associated with a specific configuration file or network element. In a static provisioning/configuration object no dependent or included objects are used and they are “stubbed” out. This allows the static provisioning/configuration object to maintain a minimum impact on the provisioning server load and resources, yet be able to stand in the place of one or more ProvisioningObjects 306, 308 in situations where they do not change. Both the static configuration file and static provisioning/configuration object are used in provisioning server embodiments of the present invention to handle special cases and allow network elements that are not specifically enabled by the provisioning server. An example of such a case is a special purpose network element that has a hand generated configuration file it needs that was provided by a manufacturer.

As stated above, each configuration object (ProvisioningObject 306, 308 ) in a provisioning server employing an object oriented approach contains attributes that define the network element being represented and methods that allow the provisioning server to easily work with and manipulate the attributes and aspects of the network elements. One such ability of the ProvisioningObjects 306, 308 is the internalization or objectization of methods to import and export configuration data from various sources to the ProvisioningObject 306, 308 instance. Such configuration data sources include, but are not limited to, text configuration files (such as ASCII formatted cable modem configuration files), binary configuration files (such as device specific binary configuration files that can be directly read in by the network element for initialization purposes), XML formatted configuration files, and information databases (such as LDAP information databases that have a specified format for configuration data). This ability to import and export from multiple sources allows the ProvisioningObjects 306, 308 to be a highly efficient configuration data conversion facility in the provisioning server, with the ability to convert from information databases to text configuration files to binary configuration files. This data conversion with provisioning objects that reuse and inherit methods from parent and other incorporated objects in a centralized approach has a simplicity in implementation is inherently less error prone from a programming perspective than past configuration data import/export/conversion in other provision server implementations that can contain multiple data import/export/conversion facilities and routines. Additionally, this approach lends itself to ease of correction as problems with data import and export generally only need to be fixed in one object location. Also, extension of configuration data import, export, and conversion capabilities to new configuration data sources is performed by simply adding a new import and export method for the data source type to a ProvisioningObject 306, 308.

This configuration data conversion ability of the ProvisioningObjects 306, 308 and their internal object methods is also utilized for efficient provisioning and generation of task specific configuration data and files from the general/generic configuration data about the elements being managed and tasks they will be applied to in the network system. In such provisioning and generation of task specific configuration data and files from the general/generic configuration data and tasks multiple methodologies are used in embodiments of the present invention depending mainly on the methods encoded into the ProvisioningObjects 306, 308. One such approach is to instantiate a single ProvisioningObject 306, 308 in a provisioning server embodiment of the present invention that imports the generic configuration data for the element and task to be provisioned. The ProvisioningObject 306, 308 instance then imports or is given the specific task and element configuration data or a range of specific task and element configuration data and commanded to directly provision the network element(s) or export one or more specific network element configurations to specified configuration files or information databases and their formats. Alternatively, the ProvisioningObject 306, 308 once it has loaded or received all specific and generic configuration data instantiates child ProvisioningObjects 306, 308 for each specific element that must be provisioned. Each child ProvisioningObject 306, 308 is then commanded to provision the represented network element or export specific network element configuration to the desired configuration file or information database and format. It is noted that other manners of operating provisioning objects to import, export, and convert configuration data and provision network elements are possible and will be apparent to those skilled in the art with the benefit of the present disclosure.

Such a provisioning approach also allows for generic configuration data to be pulled back out of task specific configuration data and files if needed by importing the configuration data and filtering out the task specific configuration data and parameters and exporting the resulting generic configuration data into the desired form and format (text configuration files, binary configuration files, and information databases of the desired format).

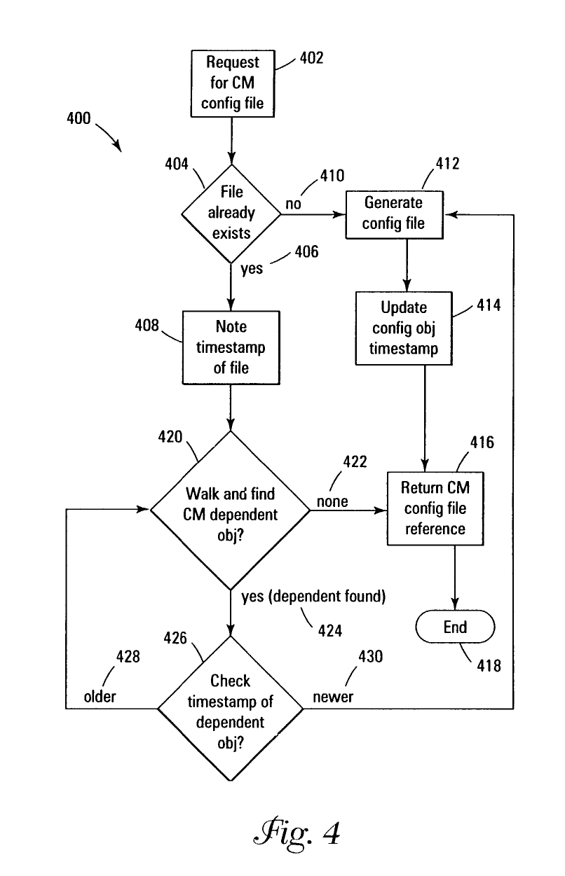

FIG. 4 is a simplified flowchart of a timestamp verification of database, files, and objects of one provisioning server embodiment of the present invention. In the flowchart of FIG. 4, a request for a CM configuration file 402 comes into a provisioning server embodiment of the present invention. The storage media of the provisioning server is checked 404 for the requested configuration file. If the configuration file does not exist 410 the file is generated 412 (from the provisioning/configuration objects which must be loaded from the database if not in the provisioning server's object cache), the provisioning/configuration objects are updated 414 to that of the generated configuration file, and the CM configuration file is returned 416 to the requesting network element (cable modem) ending 418 the provisioning request cycle. If the configuration file exists 406, the timestamp is noted 408. The configuration file is then checked to see if a provisioning/configuration object is associated 420 with it (dependent on it). If no associated provisioning/configuration object is found 422 in the provisioning server or database, the file is assumed static, and thus up to date, and is returned 416 to the requestor ending 418 the provisioning request cycle. If an associated provisioning/configuration object is found 424 in the provisioning server or database, the timestamp of the found provisioning/configuration object is compared against the timestamp of the configuration file. If the timestamp of the provisioning/configuration object is older (i.e. the configuration file is newer) 428 the configuration file is assumed to be up to date with respect to the found provisioning/configuration object and the next dependent provisioning/configuration object in the provisioning/configuration object tree is searched for. This cycle is repeated until the full provisioning/configuration object tree is walked. If no newer provisioning/configuration object is found 422 then the configuration file is assume to be up to date and is returned 416 to the requester and the provisioning request cycle is ended 418. If a newer 430 provisioning/configuration object is found in the provisioning/configuration object tree walk the configuration file is assumed to be out of date and the file is generated 412 (from the provisioning/configuration objects which must be loaded from the database if not in the provisioning server's object cache), the provisioning/configuration objects are updated 414 to that of the generated configuration file, and the CM configuration file is returned 416 to the requesting network element (cable modem) ending 418 the provisioning request cycle.

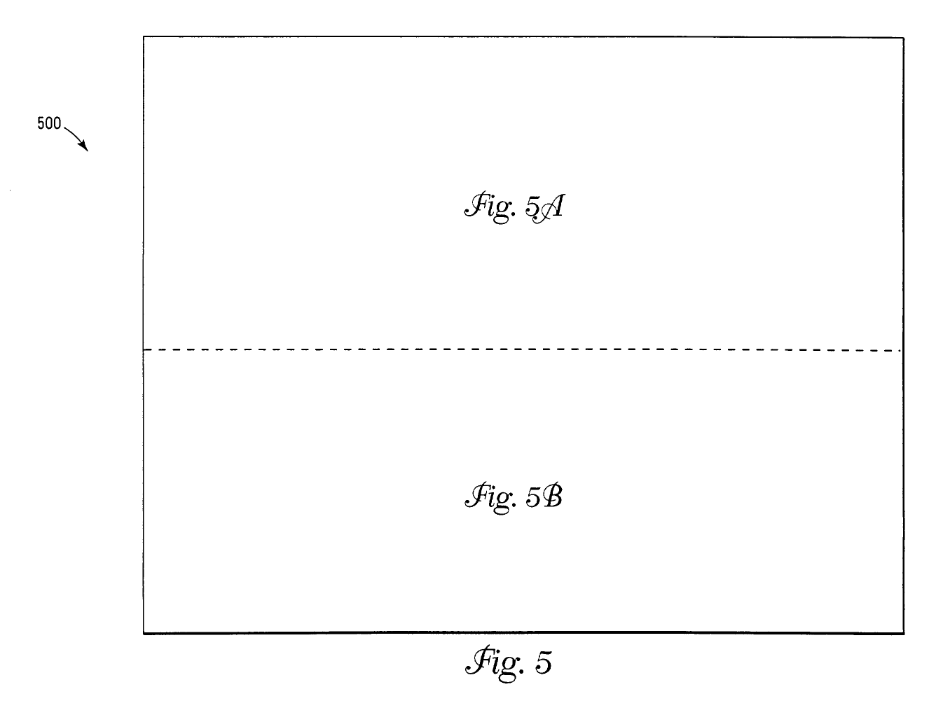

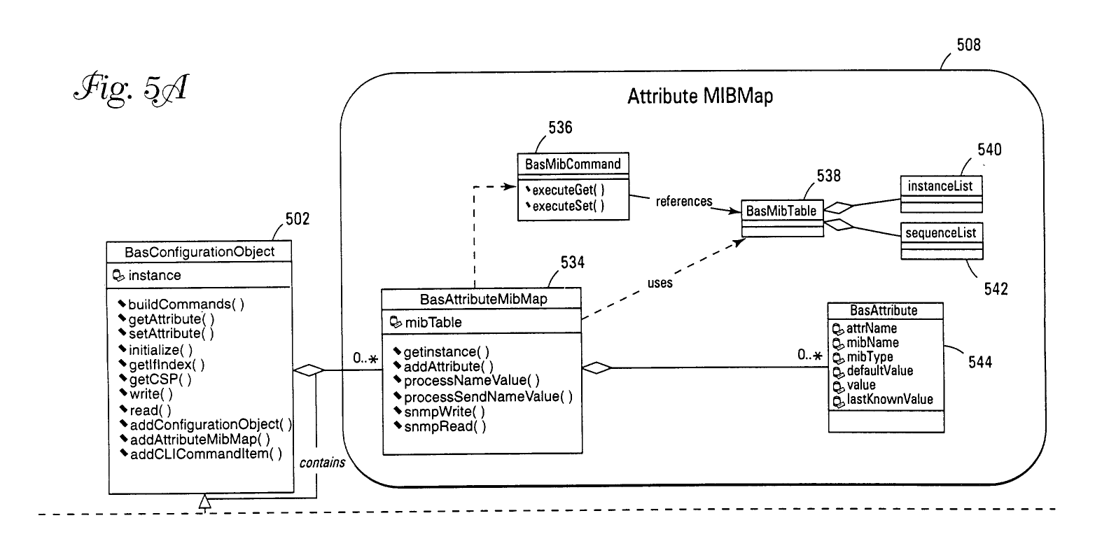

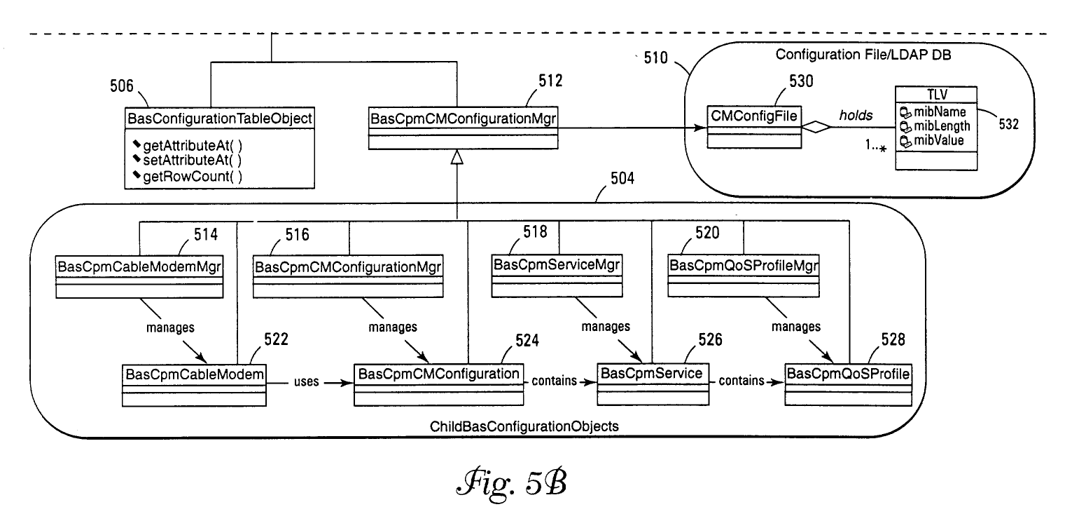

FIG. 5 is a simplified object model of another embodiment that can be utilized, for example, with the provisioning server embodiment of FIG. 3. In FIG. 5, the object model 500 includes a base configuration object (BasConfigurationObject) 502, a block of child configuration objects (ChildBasConfigurationObjects) 504, a BasConfigurationTableObject 506, a block of AttributeMIBMap objects 508, and configuration files and LDAP information database data conversion objects 510.

The BasConfigurationObject 502 is the base object class for all configuration objects 504 utilized in the object model 500. The ChildBasConfigurationObjects 504 model the specific physical and logical network elements of the system for the provisioning server and include BasCpmCableModemMgr object 514, BasCpmCableModem object 522, BasCpmCMConfigurationMgr object 516, BasCpmCMConfiguration object 524, BasCpmServiceMgr object 518, BasCpmService object 526, BasCpmQoSProfileMgr object 520, and BasCpmQoSProfile object 528. The ChildBasConfigurationObjects 504 extend the BasCpmConfigurationObject 512, which is itself an extension of the BasConfigurationObject object 502. Within the ChildBasConfigurationObjects 504, each manager object 514, 516, 518, and 520 manages its respective configuration object classes 522, 524, 526, and 528.

Each BasCpmCableModem object 522 uses a BasCpmCMConfiguration object 524 which can contain in various embodiments BasCpmService objects 526 which in turn can contain in various embodiments BasCpmQoSProfile object classes 528. The ChildBasConfigurationObjects 504 are representative of classes that extend the BasCpmConfigurationObject 512 and the BasConfigurationObject object 502 for specific network element types that are in various embodiments managed by the provisioning server.

Each class extension implements an initialization routine to instantiate any child objects. For example, the BasCpmCMConfiguration object 524 instantiates instances for each BasCpmService objects 526 associated with the network element. Each BasCpmConfigurationObject 512 and ChildBasConfigurationObject 504 communicate with objects of the configuration files and LDAP information database data conversion object block 510 to import and export configuration data to and from text configuration files, binary configuration files, XML configuration files, and the LDAP information database. It is noted that because of the configuration files and LDAP information database data conversion object block 510 in the object model of FIG. 5 the import/export functionality of configuration data is external to the configuration objects for this embodiment.

A BasConfigurationTableObject 506 is derived from the base BasConfigurationObject 502 and allows modeling of selected objects as rows within a table. Table objects are specialized objects that contain table data structures internal to the object which are utilized by the table object to virtually represent multiple other object instances. This virtual representation of what would otherwise be multiple object instances allows the table object to minimize the memory and processing impact on the provisioning server because only one table object instance need be maintained. When a method or an attribute of an object instance that is virtually represented by a table object is referenced, the table object locates the instance's representation in its internal table and references the stored methods or attributes simulating the represented object instance. The represented object instances are preferentially similar in data attribute format and object methods to minimize the size of the table object's internal data table. If the methods of the represented object instances are identical in function, only a single set of methods need be maintained by the table object to operate on attributes taken from the internal table. Similarly, if the attributes are similar in number and format a single uniform table can be used by the table object to represent them.

However, object instances with differing methods and attributes can be efficiently represented by a table object if a small enough set of total differing methods and attributes are utilized. For this approach, the table object internally keeps track of which attributes and methods of the set a represented object instance has so that it accesses the appropriate versions upon reference to the represented object instance. This table and row approach avoids a situation in which an overwhelming number of similar objects are instantiated in the provisioning server by representing such objects by row entries in the table. The BasConfigurationTableObject 506 extends from the BasConfigurationObject class 502 to support this modeling of tabular data. The BasConfigurationTableObject 506 additionally supports iteration over the rows of the table. The attributes of the BasConfigurationTableObject 506 define the columns of the table.

In the object model 500 of FIG. 5 two mappings are required to operate the provisioning server and to handle SNMP change events. The first is to map a SNMP set notification to an object attribute pair, allowing incoming configuration change events to find and modify the appropriate object instance and attribute. This mapping is the job of the objects in the AttributeMIBMap object block 508. The second is to map one or more object instance attributes to a CLI command allowing the appropriate object instances and attributes to be utilized when a CLI command is used, and allowing for CLI command set generation by the provisioning server and object model. This second mapping is an aspect of the BasConfigurationObject 502 and its method addCLICommandItem( ).

In mapping a SNMP set notification to an object attribute pair, the SNMP interface (not shown) notifies the configuration object manager (COM, not shown) when a successful configuration event (SNMP set request) is processed. This allows the COM to update the object instances 502, 512, 504 that represent of the state of the network element being provisioned. For each SNMP set notification, the COM receives a MIB name, instance, and value. The COM then updates the associated instance and attribute with the value. The update of an object instance due to a configuration event (SNMP set request) triggers rebuilding of the CLI command set for the modified object instance.

As stated above, there are two available manners to map the SNMP set event received from the SNMP interface to an object instance and attribute. First, the SNMPSetEvent is passed from parent object to child object within the BasConfigurationObject 502, 512, 504 hierarchy, using the instance to route the SNMPSetEvent to the correct object 502, 512, 504. Second, each object instance attribute registers interest for SNMPSetEvents with a notification service. When the notification service receives an SNMP event corresponding to a MIB name and instance matching a registered object instance, the notification service then notifies the attribute with matching MIB name and instance, gaining the efficiency of not having to pass the SNMPSetEvent from object to object within the BasConfigurationObject 502, 512, 504 hierarchy. The notification service/mapping is handled in one embodiment by the objects of the AttributeMIBMap object block 508.

The BasAttributeMIBMap object class 534 of the AttributeMIBMap object block 508 aggregates attributes that map to a common MIB table. The BasAttributeMIBMap object class 534 in one embodiment contains a MIB table and provides methods for initialization of the object, computing the instance, and processing (data conversion) incoming and outgoing SNMP MIB name value pairs. The BasAttributeMIBMap object class 534 also contains methods to perform SNMP sets or gets. The BasAttributeMIBMap object class 534 contains in one embodiment one or more of the BasAttribute objects 544 that contain values of the attribute name, MIB name, MIB type, default attribute value, current value, and last known value. The BasAttributeMIBMap object class 534 interfaces with the BasMIBTable 538 that contains instanceList 540 and sequenceList 542 classes to map MIB objects. Additionally, the BasAttributeMIBMap object class 534 uses the BasMIBCommand class 536 to execute gets and sets. The BasMIB classes of the AttributeMIBMap object block 508 are utilized for computing the instance, and processing incoming and outgoing name value pairs.

In the configuration files and LDAP information database data conversion object block 510, instances of the data conversion object (CMConfigFile) 530 interface to one or more specific configuration data forms (text configuration file type, binary configuration file type, or information database type). The CMConfigFile object class 530 imports and exports to and from configuration objects 502, 512, 504 of the object model and the supported configuration data form it supports. Each CMConfigFile object 530 contains one or more TLV objects 532 that contain the type-length-value (TLV) attributes for the supported configuration data form and define the specific configuration.

A simplified example of an LDAP information database schema that represents cable modem network elements for provisioning server embodiments of the present invention is shown in Table 1 and Table 2. Table 1, BASCableModem, associates specific parameters of represented cable modem with configurations. Table 2, BASCMConfiguration, holds attributes of classes of cable modems that are common and therefore only need to be represented once for the class of cable modem. This two table information database schema saves space by not having to represent the redundant data of each separate configuration in the database, and also make it easier to share configurations among network elements.

TABLE 1
BASCableModem LDAP table

| Attribute | Attribute | | |
|---|---|---|---|
| Name | Type | Description | Value |
| MacAddress | Cis, single | MAC address of the cable | Value is a colon formatted |
| | | modem. Used as the key. | MAC address. |
| Description | Cis, single | Description of the object. | |
| CPEMacAddress | Cis, multi | MAC addresses of CPEs. | Colon formatted MAC |
| | | | address. |
| CMConfigParameters | Cis, single | Pointer, key to | A unique string, key, having |
| | | BASCMConfigParameters | length 1-255 chars |
| | | table. | |

TABLE 2
BASCMConfiguration LDAP table

| Attribute | Attribute | | |
|---|---|---|---|
| Name | Type | Description | Value |
| Name | Cis, single | Name of this table entry. | Value is a string having |
| | | Used as the key. | length 1-255 chars |
| Description | Cis, single | Description of the object. | |
| Service | Cis, single | Name of the Service object | Value of key of the |
| | | for the cable modem. | BASCMService object. |
| MaxCPE | Cis, single | Max. number of CPEs | Numeric. Range 1-255 |
| UpStreamChannelID | Cis, single | | Numeric. Range 1-4 |
| DownstreamCenterFrequency | Cis, single | | Numeric. Range 1-10\hat{ }9 |
| | | | (1-1 billion) |
| CMOptionsGroup | Cis, single | BASDhcpOptionsGroup | Value of the key of the |
| | | object that defines DHCP | BASDhcpOptionsGroup that |
| | | options for the cable modem | this attribute points to. |
| AuthWaitTimeout | Cis, single | Auth req. retransmission | Numeric. Range 2-30. |
| | | interval (in seconds) from | Default=10. |
| | | Auth Wait state. | (CableLabs: Range=1-30, |
| | | | Default=10) |
| ReauthWaitTimeout | Cis, single | Auth req. retransmission | Numeric. Range =2-30 |
| | | interval (in seconds) from | Default=10 |
| | | Reauth Wait state. | (CableLabs: Range=1-30, |
| | | | Default=10) |
| CMOperWaitTimeout | Cis, single | Key req. retrans. interval (in | Numeric. Range =1-10 |
| | | seconds) from Op Wait state. | Default=1 |
| | | | (CableLabs: Range=1-10, |
| | | | Default=5) |
| RekeyWaitTimeout | Cis, single | Key req. retrans. interval (in | Numeric. Range = 1-10 |
| | | seconds) from Rekey Wait | Default=1 |
| | | state. | (CableLabs: Range=1-10, |
| | | | Default=5) |
| AuthRejWaitTimeout | Cis, single | Auth. Reject wait timeout (in | Numeric. |
| | | seconds). | (CableLabs: Range=1-600. |
| | | | Default=60) |
| ConfigFileType | Cis, single | Specifies whether the cable | String: dynamic or static |
| | | modem's configuration file | if static, the |
| | | is generated dynamically | CMConfigFileName |
| | | (based on the service) or | attribute must be present. |
| | | statically using the specified | |
| | | file. | |
| CMConfigFileName | Cis, single | The name of the | String: The name of the |
| | | configuration file the cable | cable modem's configuration |
| | | modem will TFTP download | file. |
| | | during boot up. | |
| SNMPWriteAccessContol | Cis, multi | Enables/Disables write | String. The format of the |
| | | access to SNMP MiB | value is OID/Value where |
| | | objects. | “OID“ is the string |
| | | | representation of the |
| | | | complete object Id of the |
| | | | SNMP MIB object and |
| | | | “Value” is one of 0 (allow |
| | | | write-access) or 1 (disallow |
| | | | write-access). |
| SNMPMibObject | Cis, multi | Allows MIB object values to | String. The format of this |
| | | be set. | value is OID/Type/Value |
| | | | where “OID” is the object ID |
| | | | of the SNMP object, “Type” |
| | | | is the type of the MIB object |
| | | | i.e. one of Integer, BitString, |
| | | | OctetString, OID, IPAddress, |
| | | | Counter, Gauge, TimeTicks |
| | | | and “Value” is the string |
| | | | representation of the value. |

Alternative provisioning server object model embodiments of the present invention with object oriented programming techniques and provisioning component representation will be apparent to those skilled in the art with the benefit of the present disclosure, and are also within the scope of the present invention.

### Conclusion

An object oriented network provisioning server object model and method are described that allow for improved representation and management of administered network systems and elements with an improved ability to service configuration requests. The improved provisioning server object model and method incorporates a provisioning object cache allowing for the checking if a configuration file is up to date and/or the regeneration of the configuration file with little or no accesses to the provisioning information database. The improved provisioning server object model and method also allows for dynamic update of their internal configuration components upon receiving a configuration change event and, additionally, allow for generation of a logically arranged CLI command set without excessive loading of the provisioning server or degradation of its performance. The improved provisioning server object model allows for ease of configuration file import, export, and conversion to and from multiple configuration file formats and information databases. Additionally, the provisioning server object model allows for efficient and reduced error implementations of instances of the provisioning server with ease of extension to new additional modules and elements.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An object model, comprising:
a plurality of objects, the plurality of objects adapted to contain configuration information and data for a provisioning server.

2. A method of forming an object model for a provisioning server, comprising:
receiving configuration input; and
representing the received configuration input in object instances of a plurality of objects, the plurality of objects forming an object model.

3. The method of claim 2, wherein receiving configuration input further comprises receiving configuration input where the input is selected from the group consisting of configuration files, information databases, and configuration change events.

4. A computer-usable medium having computer readable instructions stored thereon for execution by a processor to perform a method comprising:
receiving configuration input;
representing the received configuration input in object instances of a plurality of objects, the plurality of objects forming an object model; and
responding to requests for configuration information from one or more elements of a network.

5. The method of claim 4, wherein receiving configuration input further comprises receiving configuration input where the input is selected from the group consisting of configuration files, information databases, and configuration change events.

6. A provisioning server comprising:
a memory;
a network interface;
a processor coupled to the memory and the network interface; and
an object model, the object model comprising:
a plurality of objects, the plurality of objects adapted to contain configuration information and data for network elements of a network system managed by a provisioning server.

7. An object model for a provisioning server, comprising:
a plurality of objects, the plurality of objects adapted to contain configuration information and data for one or more input configuration datum.

8. In a provisioning server having a memory, a network interface,
a computer-usable medium for storing computer readable instructions, and
a processor coupled to the memory, the computer-usable medium, and the network interface, an object model, comprising:
a plurality of objects, the plurality of objects adapted to contain configuration information and data for one or more input configuration datum.
